(19) United States
(12) Patent Application Publication
(10) Pub. No.: US 2002/0186410 A1
(43) Pub. Date: Dec. 12, 2002

(54) Apparatus and method of controlling plural processing modules

(76) Inventor: Toshiaki Tanaka, Hiratsuka-City (JP)

Correspondence Address: VARNDELL & VARNDELL, PLLC, 106-A S. COLUMBUS ST., ALEXANDRIA, VA, 22314, US

(21) Appl. No.: 10/162,662

(22) Filed: Jun. 6, 2002

(30) Foreign Application Priority Data
Jun. 7, 2001 (JP) 2001-173022

(51) Int. Cl. B41J 1/00; G06F 15/00

(52) U.S. Cl. 358/1.15; 358/1.1

(57) ABSTRACT

When there are any problems in a device in a print server which the user wants to allow to execute a job, another device that can execute the job exactly is automatically selected and the job is sent thereto. The print server manages plural printers. The print server, upon reception of print job data including printer specification from a client, checks status of the specified printer in a data distributing section. When its status has some problem, the print server, in accordance with a print redirecting method that has been previously set in a writable nonvolatile memory by the user, selects another printer that is in a normal state, and sends print data of its print job to another printer that has been selected.

### BACKGROUND OF THE INVENTION

1. Field of the Invention

The present invention relates to an apparatus of controlling plural processing modules, such as a print server of controlling plural printers, and its method.

In the invention, a term of “module” is used with wide meaning including a system, an equipment, an apparatus, parts, a program, a sub-program, and a process.

2. Description of the Related Art

For example, in a LAN including plural client computers and plural printers, a print server is frequently used in order to concentratedly control the plural printers. The print server is connected to the plural printers, receives a print job through the LAN from each client computer, and sends its print job to some printer.

The conventional print server receives, from the client computer which issues the print job, specification of; which printer its print job is set to. The conventional print server, when receives the print job, if the specified printer is in a unprintable state, remains holding its print job without sending the print job to any printer till its printer returns to a printable state or an instruction of canceling the print job is given from the client.

In the conventional print server, when a printer specified by a user is in the unprintable state, he cannot receive print results as long as he does not wait till its printer returns to the printable state, or as long as he does not specify another printer and does not reissue the print job.

Similar problems exist not only in the print server but also in a control apparatus of a processing module that executes another kind of processing.

### SUMMARY OF THE INVENTION

Therefore, it is an object of the invention to, when the user intends to have some processing module execute a specified processing, in case that its intended processing module is in a unprocessible state, select automatically another processing module and allow it to execute the same processing, that is, to redirect automatically the processing module.

Another object is, when the processing module is going to be redirected, to specify a processing module which can execute the processing properly as a redirecting-side module.

An apparatus of controlling plural processing modules according to the invention includes a check unit which checks a state of one processing module which will perform the specified processing, in the plural processing modules; a redirecting unit which selects from other processing modules, when the state of the specified module has some problem as a result of the check, a processing module of a redirecting side; and a control unit which controls the processing module of the redirecting side and allows it to perform the specified processing.

Preferably, this apparatus includes further a setting unit which receives setting of a redirecting method from the user and records it, and the redirecting unit, in accordance with the redirecting method set by the user, selects the processing module of the redirecting side from other modules.

More preferably, this apparatus includes further a unit which informs the user of the set redirecting method, and a unit which informs the user that redirection will be performed.

### BRIEF DESCRIPTION OF THE DRAWINGS

FIG. 1 is a block diagram showing a constitutional example of a computer system to which a print server according to one embodiment of the invention can be applied;

FIG. 2 is a block diagram showing another constitutional example of a computer system to which the print server according to one embodiment of the invention can be applied;

FIG. 3 is a block diagram showing the functional constitution of the inside of the print server;

FIG. 4 is a flowchart showing a flow of operations since the print server received print job data till it feeds out print data to a printer;

FIG. 5 is a diagram showing an example of a Web page for referring to and setting a print redirecting method;

FIG. 6 is a diagram showing an example of a Web page for setting a printer group and a printer that is out of an object of redirection; and

FIG. 7 is a diagram showing an example of a Web page for referring to print data and job history.

### DETAILED DESCRIPTION OF THE INVENTION

One embodiment of the invention applied to a print server will be described below.

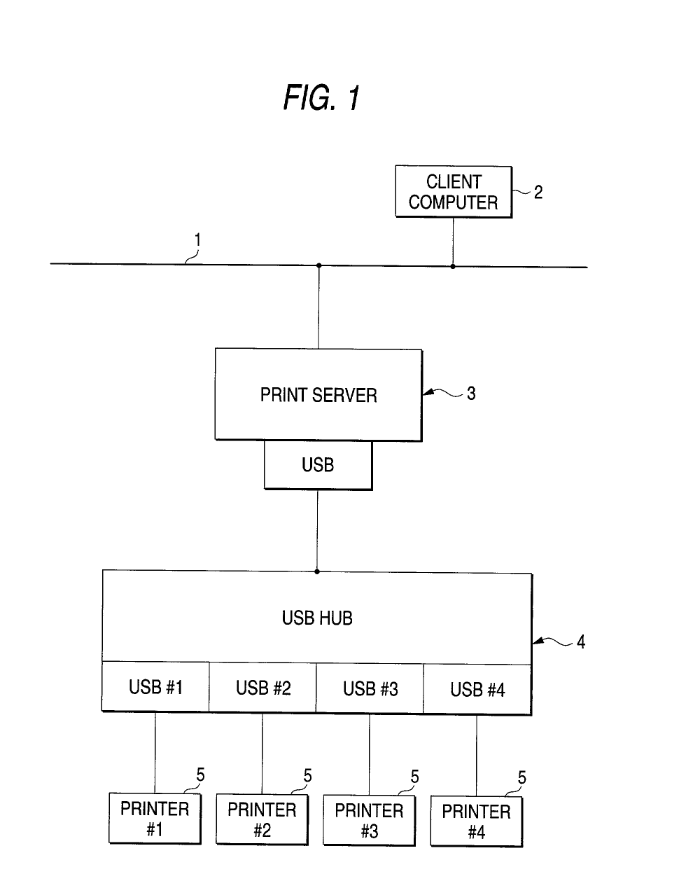

FIG. 1 shows a constitutional example of a computer system to which a print server according to one embodiment of the invention can be applied.

As shown in FIG. 1, a client computer 2(hereinafter referred to as a client) and a print server 3 are connected to each other through a LAN 1 such as Ethernet. Though only one client 2 is shown in FIG. 1, actually rather plural clients exist. The print server 3 has a host side port of USB, to which plural (in the shown example, four printers) printers (printers #1 to #4) 5, 5, 5, 5 are connected through a USB hub 4. The client 2 has a printer driver (not shown) corresponding to the used printer, and a World Wide Web browser (not shown).

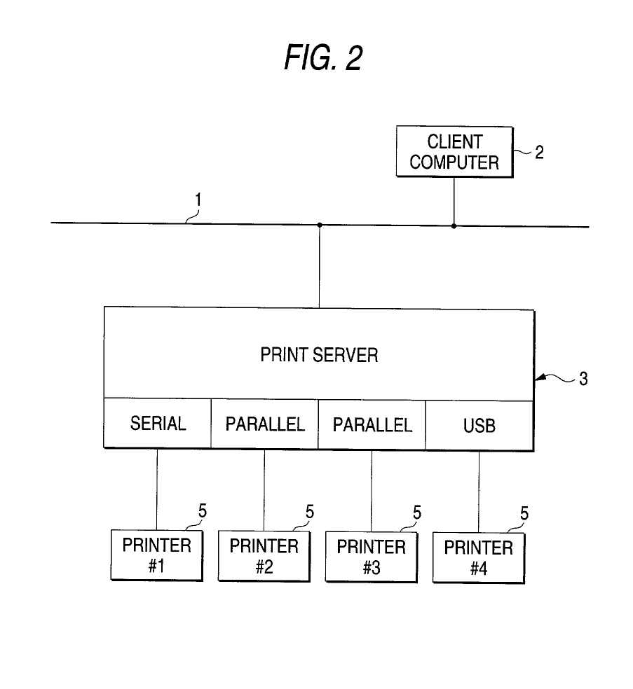

FIG. 2 shows another constitutional example of a computer system to which the print server according to one embodiment of the invention can be applied.

In the system shown in FIG. 2, a print server 3 has plural (four in the shown example) communication ports such as a serial port, a parallel port, and a USB port, and printers (printer #1 to #4) 5, 5, 5, 5 are respectively connected to their communication ports. A client 2 has a printer driver (not shown) corresponding to the used printer, and a World Wide Web browser (not shown).

In the system shown in FIG. 1 or 2, the client 2, when it intends to perform printing, specifies a printer to be used using the printer driver, creates print job data including print data to be given to the printer, and sends the print job data to the print server 3. The print server 3, using the print job data received from the client 2, identifies the specified printer, and sends the print data to the specified printer 5.

When the print server 3 receives the print job data from the client 2, in case that the printer specified by the client 2 is in a unprintable state (for example, busy, error and the like), the print server 3 selects another printer which is in a printable state than the specified printer from the printers #1 to #4 connected to the print server 3, and sends the print data to the selected printer. This operation hereinafter is referred to as “redirection of printer” or “print redirection”. Selection of the printer of the print redirecting side is performed in accordance with a print redirecting method previously set in the print server 3 by the user (particularly, system administrator).

As the print redirecting method, for example, the following plural methods are prepared in the print server 3.

(0) Not redirect

(1) Redirect to printer of the same name brand

(2) Redirect to printer of the same model

(3) Redirect to printer in the same group

(4) Redirect to all printers

In case that the print redirecting method is set, the user (particularly, system administrator) logs in the print server 3 from the World Wide Web browser of some computer on the LAN 1 with the name of the system administrator and a password. Then, since a Web page for setting the print redirecting method in which the prepared plural methods are displayed can be opened, he selects the arbitrary method on the page. Further, other general users than the system administrator can also open the Web page for setting the print redirecting method to see the present setting of the print redirecting method. However, they can only refer to the present setting but cannot change or cancel it.

The print server 3, on each of the connected printers #1 to #4, manages and stores its present status and the history of the job that was executed (and the job that is being executed). When the user logs in the print server 3 from the World Wide Web browser of the client 2, he can open a Web page for reference in which the present states and the job histories of the printers #1 to #4 are displayed. In the job history of each printer displayed on the page, in case that its job has been redirected to its printer from another printer, which printer the job has been redirected from is displayed. Therefore, by seeing it, the user knows which printer the job that he has issued has been redirected to.

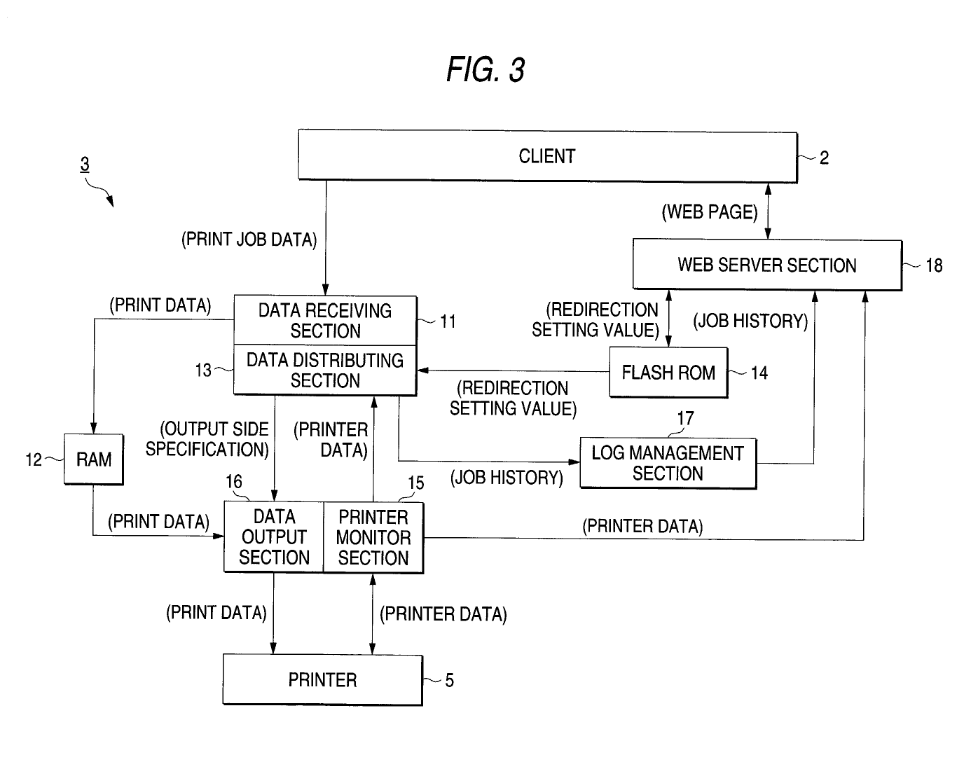

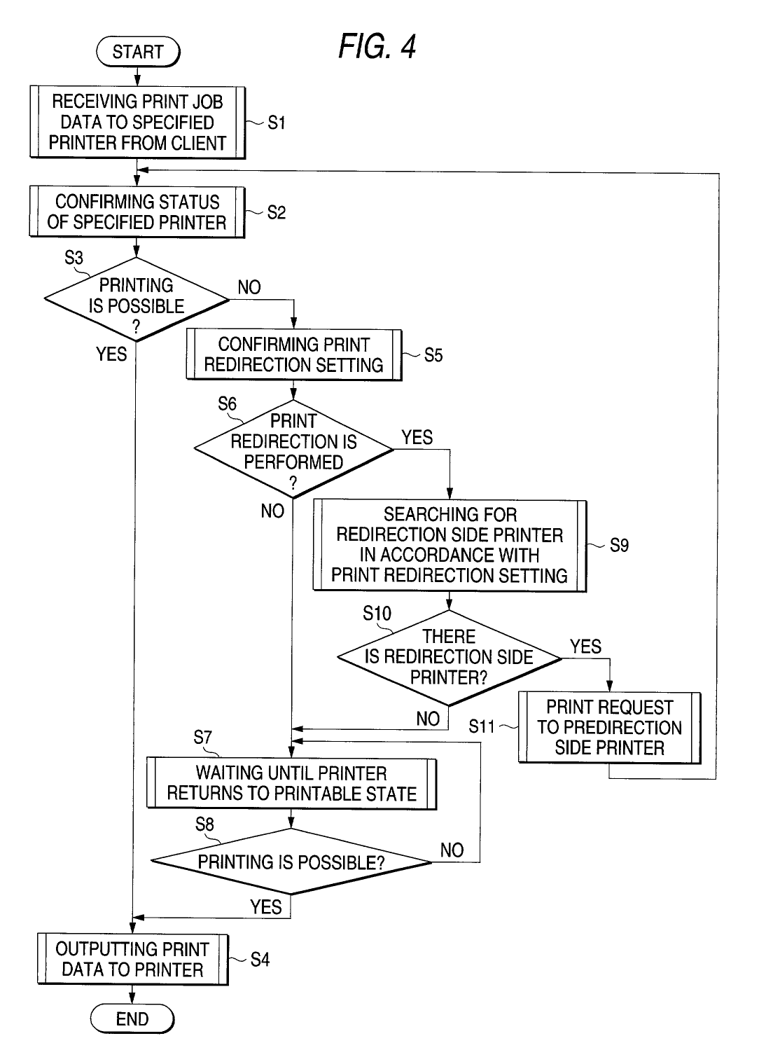

FIG. 3 shows the functional constitution of the inside of the print server 3. FIG. 4 shows a flow of operations since the print server 3 received print job data till it feeds out print data to a printer.

Referring to FIGS. 3 and 4, the constitution, the function, and the operation of the print server 3 will be described.

A data receiving section 11 of the print server 3 receives print job data issued from the client 2 (S1). Though there are many types of the print job data, a CPR print type is used in this embodiment. Namely, as the print job data, firstly printer specifying data representing a printer specified by the client 2 is received by the data receiving section 11, and thereafter print data to be sent to the specified printer is received. When the printer specifying data has been received, negotiation is performed between the print server 3 and the client 2. After the negotiation has been completed, the print data is fed out from the client 2. The data receiving section 11 passes the received printer specifying data to a data distributing section 13, and writes the print data received thereafter into a RAM 12 functioning as a reception buffer.

The data distributing section 13 is used in order to determine which printer the print job is executed by, and specifically, it operates as follows.

The data distributing section 13 analyzes the received printer specifying data and detects which the printer specified by the client is. At this time, the data distributing section 13 receives from a monitor section 15 printer data on the printers #1 to #4 that are being connected to the print server 3. The printer data of each printer includes property data representing properties such a maker of its printer, a model (type), and equipments (various kinds of paper feeders), and status data representing the present status of its printer such as Stop, On-line wait, Printing, Busy (Since the printer is receiving or processing another data, it cannot receive new print data), Error, and Error kinds (No paper, Paper jam, No toner).

The data distributing section 13 judges, on the basis of the printer data of the printer specified by the client, whether the specified printer is in a printable state or not (S2). For example, in case that the printer status which the printer data represents is Stop, Busy, or Error, the section 13 judges that the printer status is unprintable (S3, No); and in case that the printer status is in other states, it judges that the printer status is printable (S3, Yes).

When the printer specified by the client is in the printable state (S3, Yes), the data distributing section 13 passes output-side specifying data representing the printer specified by the client to a data output section 16. Then, the data output section 16 transmits the print data read out from the RAM 12 to the printer shown by the output-side specifying data, that is, to the printer specified by the client (S4).

On the other hand, when the printer specified by the client is in the unprintable state (S3, No), the data distributing section 13, from a rewritable nonvolatile memory (for example, flash ROM) 14 that is storing properties of the print server 3 such as IP address of the print server 3 and setting of print redirecting method, reads a redirecting setting value representing the print redirecting method that is set at the present time (S5). The data distributing section 13, from the redirecting setting value, judges whether print redirection is performed or not (S6). In case that the print redirection is performed (S6, Yes), the data distributing section 13, depending on the printer data of each printer, searches for a printer that can be specified as a redirecting side from other printers than the printer specified by the client in accordance with the print redirecting method that is set at the present time (S9).

For example, in case that the print redirecting method set at the present time is “redirection to a printer of the same maker brand”, the data distributing section 13 searches for a printer of the same maker brand as the printer specified by the client. Further, in case that the print redirecting method set at the present time is “redirection to a printer of the same model”, the data distributing section 13 searches for a printer of the same mode as the printer specified by the client. Furthermore, in case that the print redirecting method set at the present time is “redirection to a printer in the same group”, the data distributing section 13 searches for a printer in the same group as the printer specified by the client. Furthermore, in case that the print redirecting method set at the present time is “redirection to all printers”, the data distributing section 13 searches for other printers connected to the print server 3 than the printer specified by the client. Further, a specific printer can be previously specified as a printer that is out of an object of the redirecting side. The thus set printer is out of the search for the redirecting side.

In case that more than one printers to be selected as the redirecting side has been searched for (S10, Yes), the data distributing section 13 selects one printer from the searched printers as the redirecting side (S11). Then, the section 13 judges from the printer data of its selected printer whether the printer is in the printable state (S2, S3). In case that the printer is in the printable state (S3, Yes), the section 13 passes the output-side specifying data that has specified the printer of the redirecting side to the data output section 16. Then, the data output section 16 transmits the print data read from the RAM 12 to the printer specified by the output-side specifying data, that is, the printer selected as the redirecting side (S14).

In case that the printer selected as the redirecting side is in the unprintable state (S3, No), the data distributing section 13 searches again for another printer to which the redirection is given (from S5 on).

In case that the present print redirecting setting is “Not redirect” (S6, No), or in case that there is no printer of the redirecting side that is in the printable state (S10, No), the data distributing section 13 refers to the printer status which the printer data of each printer represents, and waits till either the printer specified by the client or the printer selected as the redirecting side which was in the unprintable state returns to the printable state (S7, S8). When either of their printers returns quickly to the printable state (S8, Yes), the section 13 passes the output-side specifying data that has specified its printer to the data output section 16. Then, the data output section 16 transmits the print data read form the RAM 12 to the printer specified by the output-side specifying data (S14).

By the above operation of the data distributing section 13, when the printer specified by the client is printable, the print data is sent to its printer. However, when its printer is unprintable, in accordance with the print redirecting method set previously by the system administrator, the print redirection is given automatically from the printer specified by the client to another printable printer.

As described above, when the print redirection is performed, the data distributing section 13 refers to the printer data which the printer monitor section 15 has. The printer monitor section 15, when each printer is connected to the print server 3, or when each printer is switched on, acquires the printer data from its printer. The printer properties such as a printer maker and a printer model can be settled by the acquired printer data. Further, the printer monitor section 15, when the data distributing section 13 refers to the printer data, acquires the printer data at that time from each printer, so that it can give the latest printer data (particularly, the latest status data) to the data distributing section 13, periodically or on occasion such as when the printer data is required from the data distributing section 13.

As described above, the present redirecting setting value is stored in the flash ROM 14. The redirecting setting value in the flash ROM 14 is referred to not only by the data distributing section 13 but also by a Web server section 18. The Web server section 18 provides, by a World Wide Web method, screens for referring to the print redirecting method set at the present time, the present property and status of each printer, and the job executed history of each printer to each user of the LAN 1 or the system administrator. Further, the Web server section 18 provides to the system administrator a screen for performing new setting or setting change of the print redirecting method.

Namely, the Web server section 18, on the basis of the redirection setting value in the flash ROM 14, creates a Web page representing the present print redirecting method. Further, the Web server section 18 refers to the printer data of the printers #1 to #4 which the printer monitor section 15 has, and the job history data of the printers #1 to #4 which a log management section 17 has, and creates a Web page representing the printer data of the printers #1 to #4 and their job history. When the Web server section 18 is logged in by the user of the LAN 1 using the Web browser of the client 2, it sends the above Web page to the Web browser to display it. In case that the Web server section 18 is logged in by other general users than the system administrator, it sends only a Web page for reference to the Web browser of its user. On the other hand, in case that the Web server section 18 is logged in by the system administrator, it sends to the Web browser of the system administrator Web pages including a page for performing new setting or setting change of the print redirecting method.

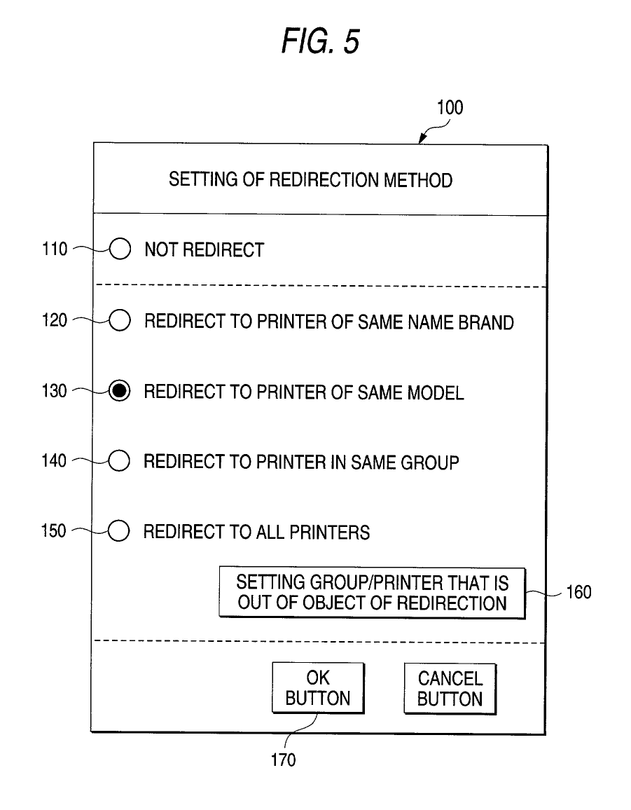

FIG. 5 shows an example of the Web page for referring to and setting the print redirecting method.

As shown in FIG. 5, on this page the plural print redirecting methods as described before are displayed together with corresponding radio buttons 110 to 150. For example, in case that a method of “Redirect to printer of same model” is set, as shown in FIG. 5, a radio button 130 corresponding to its method is marked and an “OK” button 170 is pushed on.

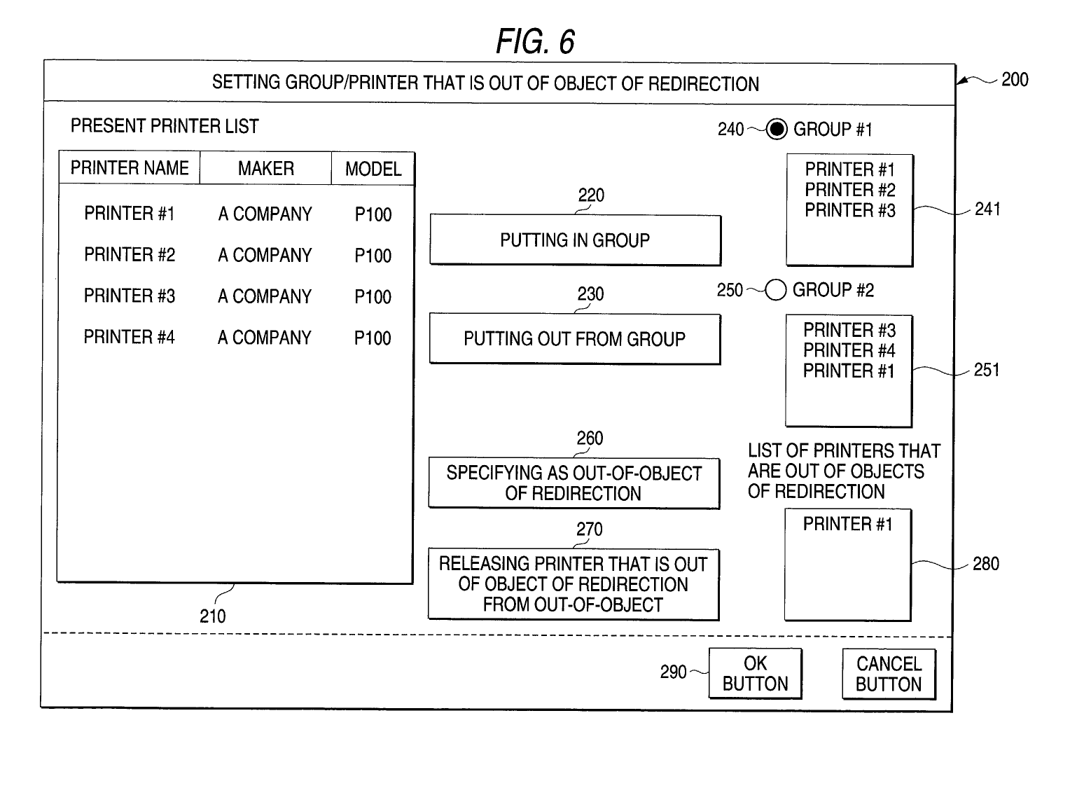

When the button 160 in this page representing “setting of group/out-of-object of redirection” is pushed on, as shown in FIG. 6, a Web page for setting a group of a printer and setting printers that are out of objects of redirection is displayed.

As shown in FIG. 6, on the left side of this page, there is a present printer list 210, in which a printer name, a maker and a model of each of the printers #1 to #4 connected to the print server 3 at the present time are displayed. On the right side of this page, there are radio buttons 240, 250 of the predetermined number (for example, two) of groups #1, #2, and group printer lists 241, 251. In the group printer lists 241, 251, names of printers belong to the respective groups are displayed. Further, on this page, there is an out-of-object printer list 280, in which a name of printer set as an out-of-object of redirection is displayed.

In order to put, for example, the printer #1 in the printer group #1, the printer #1 in the present printer list 210 is selected; the radio button 240 of the printer group #1 is marked; and a button 220 of “putting in group” is pushed on. Further, in case that, for example, the printer #1 is put out of the printer group #1, the printer #1 in the group printer list 241 of the printer group #1 is selected, and a button 230 of “putting out of group” is pushed on.

Thus setting the group is effective to a case where the method of “redirect to a printer of the same group” is set. For example, as shown in FIG. 6, in case the printers #1, #2 and #3 belong to the group #1, and the printers #3, #4 and #1 belong to the group #2, the print redirection is performed among the printers #1, #2 and #3 or among the printers #3, #4 and #1. However, the print redirection is not performed between the different groups, for example, between the printers #2 and #4.

In the FIG. 6, in order to set, for example, the printer #1 to the out-of-object of redirection, the printer #1 in the present printer list 210 is selected, and a button 260 of “specifying as out-of-object” is switched on. Further, in case that, for example, the printer #1 set to the out-of-object of redirection is released from the out-of-object, the printer #1 in the out-of-object printer list 280 is selected, and a button 270 of “releasing from out-of-object” is pushed on.

In case that some printer is thus set to the out-of-object of redirection, even if any print redirecting methods are set, its printer is not selected as a redirecting side. However, when its printer is unprintable, the redirection can be given to another printer. When the user wants to reserve some printer for urgent printing or important printing, its printer can be set to the out-of-object of redirection.

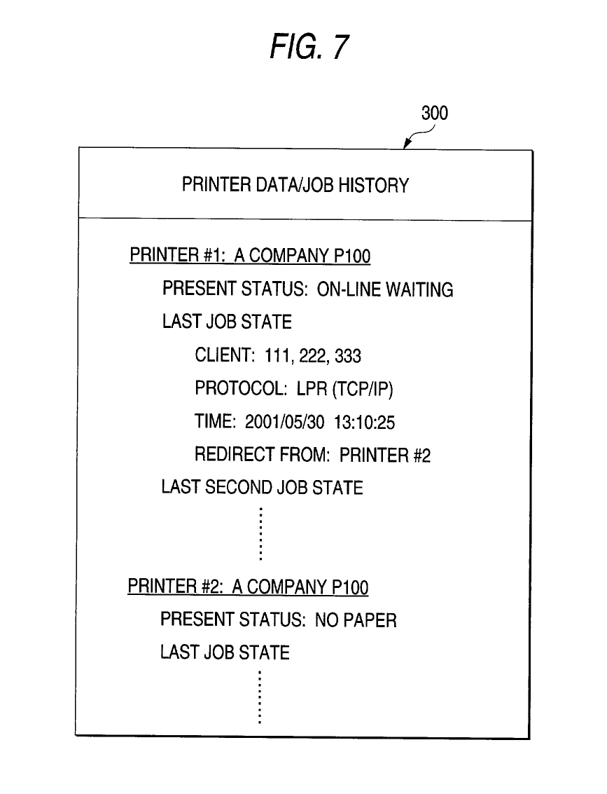

FIG. 7 shows an example of the Web page for referring to printer data and job history.

As shown in FIG. 7, on this page, regarding each of the printers #1 to #4 connected to the print server 3, a printer name, a maker, a model, the present status, history of the predetermined number of print jobs including the print job that was been executed lastly (or the print job that is being executed at the present time), which were executed recently are displayed. The history of each print job includes identification (for example, IP address) of the client who issued its print job, communication protocol when the print job has been received from the client, and reception time (or print time). Further, the history of each print job displays, in case that its job is a job that was redirected from another printer, a printer from which the redirection was given (that is, the printer specified by the client), whereby the user, in case that the print job that he has issued has been redirected, can know its fact.

Though the embodiment of the invention has been described above, since this is an example for explaining the invention, the invention is not limited to this embodiment. Accordingly, the invention may be embodied in several forms without departing from the spirit of essential characteristics thereof.

Though in the above-mentioned embodiment, regarding the print job data, the CPR printing system has been adopted, another system may be adopted. For example, in case that a RAW printing system of TCP/IP is adopted, the print job data does not include the printer specifying data from the client (that is, it includes virtually only the print data), and a printer to perform printing is previously specified by TCP/IP number. Even if the print job data system is thus another system, the invention can be applied.

In the embodiment, a printer driver program adapted to each printer model is mounted on the client, and the print data is created on the client side in a form depending on the specified printer model and sent to the print server. However, the different constitution from this can be adopted. For example, on the print server, various printer driver programs respectively adapted to the various printer models connected to the print sever are mounted, the print data is fed out from the client in a form not-depending on each printer model, and the received print data may be converted on the print server side into print data depending on the printer model actually used.

The invention can be applied also to an apparatus of controlling other processing modules than the printer. For example, when some data is going to be written into some memory device (memory place) or some data is going to be read out from its memory device (memory place), in case that its memory device (memory place) has any problems, the data writing processing or the data reading processing is redirected to another substitutive memory device (memory place). This invention can be applied also to this case. Further, for example, when some file is going to be opened by some program, in case that its program has any problems, the processing of opening its file is redirected to another substitutive program. The invention can be applied also to this case.

Further, in the embodiment, using the job history, the fact that the redirection was performed is later informed of the user. As another method, when the redirection is performed, from what printer and to what printer the redirection is given may be informed of the client. Alternatively, before the redirection is going to be performed, its intention is informed of the client, whether execution of the redirection is good or not is inquired of it, and the redirection may be performed after the permission of redirection was given from the client.

What is claimed is:

1. An apparatus of controlling plural processing modules comprising:
a check unit which checks a state of one processing module which will perform a specified processing, in the plural processing modules;
a redirecting unit which selects, when the state of the specified module has some problems as a result of a check, from other processing modules a processing module of a redirecting side; and
a control unit which controls the processing module of the redirecting side and allows it to perform the specified processing.

2. The apparatus according to claim 1, further comprising a setting unit which receives setting of a redirecting method from a user and records it, in which the redirecting unit, in accordance with the redirecting method set by the user, selects the processing module of the redirecting side from the other modules.

3. The apparatus according to claim 1, further comprising a unit which informs a user of a set redirecting method.

4. The apparatus according to claim 1, further comprising a unit which informs a user that the specified processing will be performed by the processing module of the redirecting side.

5. A method of controlling plural processing modules comprising the steps of:
checking a state of one processing module which will perform a specified processing, in the plural processing modules;
selecting, when the state of the specified module has some problems as a result of a check, from other processing modules a processing module of a redirecting side; and
controlling the processing module of the redirecting side and allowing it to perform the specified processing.
